(19) United States
(12) Patent Application Publication
(10) Pub. No.: US 2018/0213761 A1
(43) Pub. Date: Aug. 2, 2018

(54) Motion Sensing Fish Bite Alarm

(71) Applicant: Steven Carkner, Ottawa (CA)

(72) Inventor: Steven Carkner, Ottawa (CA)

(21) Appl. No.: 15/886,783

(22) Filed: Feb. 1, 2018

Related U.S. Application Data
(60) Provisional application No. 62/453,447, filed on Feb. 1, 2017.

(51) Int. Cl. A01K 97/12

(52) U.S. Cl. CPC A01K 97/125; G08B 5/22

(57) ABSTRACT

A fish bite monitoring system is provided. In an embodiment, one or more motion sensors are attached to fishing equipment. The motion sensors are paired with one or more receivers, such that the motion of a fishing rod, with an attached sensor, will trigger an alarm in the attached motion sensor. The alarm in the attached motion sensor will also wirelessly transmit the alarm to one or more of the recievers. The monitoring system allows for a plurality of fishing rods to be monitored, wherein a user may configure which receiver will be alarmed when motion is detected one of the fishing rods.

### CROSS-REFERENCE TO RELATED APPLICATION(S)

The present application claims priority to U.S. Provisional Patent Application No. 62/453,447 filed on Feb. 1, 2017, entitled “Motion Sensing Fish Bite Alarm” the entire disclosure of which is incorporated by reference herein.

### BACKGROUND OF THE INVENTION

There are many fishing products designed to sense when a fish is biting at a line or has been hooked. Fishing alarms have been in existence for hundreds of years, wherein the concept of signalling a bite can be traced back to people who would attach bells or other auditory signals to their fishing rods, or tie the line to a body part such as a toe so they could take a nap on shore and be awoken by the tug of a biting fish.

More recent fish bite detectors or alarms can be broadly categorized as one or more of: tilt-sensors (when the arm holding the fishing line is tilted or rotated it triggers an alarm); line-sensors (monitoring the tension on the fishing line as an indication of a bite); vibration sensors (monitoring movement at the rod-tip where motion is an indication of a bite); or floaters (a floating sensor that may trigger an alarm when it is submerged by the tug of a fish).

Tilt sensors generally work through the use of an electrical switch or rotational potentiometer that is open in one position and closed in another position. U.S. Pat. No. 3,890,734 provides a good example of this arrangement. These sensors can be attached to a fishing rod which is held at a fixed position. When a fish is hooked it bends the fishing rod changing the angle of the sensor. However, in order to achieve this, considerable angle is required and the fish must possess sufficient strength to bend the rod. These sensors are therefore considered very unreliable except in specific fishing circumstances such as tip-up or tip-down alarms that are, by their nature, set up to tilt when even a small fish bites the bait.

Line-sensing systems such as those described in U.S. Pat. Nos. 5,586,402, 4,118,882, 6,708,441, and many others, is that it requires a substantially large fish to pull the line tight. Many fish species do not immediately bite hard and pull a line tight, rather they tend to take a small taste of the bait first. These fish will shy away from a bait if they feel any tension when they taste it. Line measuring systems are also incompatible with some types of fishing, for example the use of a tip-up for ice-fishing where the line is held on a spool underwater (to prevent it from freezing). Line sensing systems also do not work for trolling where the fishing line is under constant, considerable tension as the boat moves through the water dragging the bait on the line behind the boat.

Line sensors are also incompatible with jigging style of fishing. It is advantageous for a user to move the rod in a fashion that imparts movement to the bait. Since most line-sensing systems are integrated into a stand that holds the fishing rod, lifting the rod from the stand to impart movement will trigger the alarm, or prevent the alarm from working effectively.

Some line sensing systems are mounted on the rod near the fishing reel. For example U.S. Pat. No. 9,179,659 discloses a monitor that senses when line is being pulled off the reel. This requires the fish to fully take the bait and will not be triggered by a very small fish or by a large fish that is only tasting the bait.

Rod-tip sensors such as that shown in U.S. Pat. No. 5,228,228 (Meissner), utilize a helical spring switch for detecting small vibrations at the rod tip mitigating many of the problems associated with line-tension based alarms. Meissner anticipates that different situations may require different sensitivity and provides a manual mechanical means to adjust the spring such that different levels of vibration are required to trigger an alarm.

The disadvantage of existing vibration sensing fish alarms is the lack of sensitivity adjustment, electronic or otherwise. For example, if a user is in a boat and the wind changes or the boat position changes, the vibration profile seen at the rod will also change and would require continuous adjustment by the user in order to prevent false alarms while still remaining sensitive enough to detect a bite.

In addition, vibration-sensing alarms generally cannot detect small tilting motions for situations such as ice-fishing tip-up or tip-down rods. Therefore vibration-based detectors cannot be used in all fishing situations.

A float-based fishing system such as that described in U.S. Pat. No. 7,131,231 may detect the motion of a float attached to the fishing line through vibration or by sensing when the float (or bobber) is partially or fully submerged under the water surface. Float-based systems generally include a light for night fishing and may include a wireless transmission to a receiver located on shore. Unfortunately, float-based systems are prone to false triggering, especially due to changing wind, waves or passing boats, where the float may be accidentally submerged. Floats are also incompatible with many fishing situations such as trolling (where a line is dragged behind a boat) or ice fishing.

Several existing bite detectors include a point-to-point wireless alarm function. However, none of those include an ability to create a simultaneous many-to-one and one-to-many style network that would allow more than one user to be alerted to a bite at a given sensor, and to enable a single user to monitor multiple sensors. For some people, fishing is a social activity and sharing the excitement of a bite is more rewarding and enjoyable for those present.

Existing wirelessly-enabled bite detectors also rely on a receiver to alert the user that a bite has occurred. When the transmitter in such systems is used without a receiver, it becomes useless to the user.

Prior art fish alarm systems provide an alarm indication at the strike and while the fish is biting, and in some cases for a short time thereafter. Prior art fishing alarms typically rely on either a tilt-detector which contains mercury or a round conductive ball, or they rely on vibration detection which consists of a spring contact that wiggles, thereby touching a nearby contact when exposed to vibration. The use of only a vibration sensitive or tilt sensitive element restricts the types of fishing equipment that can be monitored, and the type of motion that is noticed.

However, there remains a need for a fish bite detection system that can be used in a broad range of fishing situations including ice fishing, trolling, shore fishing, cast fishing and jigging and that is sensitive to vibration, tilting and other motion of the sensor. There further exists a need for a fish bite detection system that can be electronically adjusted for sensitivity, and that can automatically adjust to varying environmental conditions and therefore discern between a bite and wind or waves.

There also remains a need for a fish bite detector to provide historical information so a user knows if they missed a bite and need to check their bait. Furthermore, a fish bite detector that contains both a local alarm at the rod and a remote alarm with one or more users, wherein both the local alarm and the remote alarm can be monitored and silenced by multiple devices, and many alarms may be monitored by a single device, in a many-to-one and one-to-many network.

### SUMMARY OF THE INVENTION

A fish bite monitoring system is provided. In an embodiment, the monitoring system comprises one or more motion sensors. Each motion sensor has an alarm, an interface, and a wireless transceiver.

In an embodiment, the monitoring system is further comprised of one or more receivers. Each receiver has an alarm system, wireless transceiver, and a user interface.

In an embodiment, a motion sensor is attached to a fishing rod. Motion of the fishing rod triggers the alarm of the motion sensor. Furthermore, the alarmed motion sensor triggers the alarm system of one or more receiver which it is paired with.

In an embodiment, multiple motion sensors may be used to monitor multiple fishing rods. In the embodiment, a user can configure which motion sensors are paired with which of the recievers.

The foregoing, and other features and advantages of the invention, will be apparent from the following, more particular description of the embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows a block diagram of a representative system according to an embodiment of the present invention;

FIG. 2 shows a block diagram of a sensor according to an embodiment of the present invention;

FIG. 3 shows the construction of an example motion detector according to an embodiment of the present invention;

FIG. 4 shows a block diagram of a receiver according to an embodiment of the present invention;

FIG. 5 shows a sensor mounted on an ice fishing rod according to one embodiment of the present invention; and

FIG. 6 shows an example display according to one embodiment of the present invention.

### DETAILED DESCRIPTION OF EMBODIMENTS

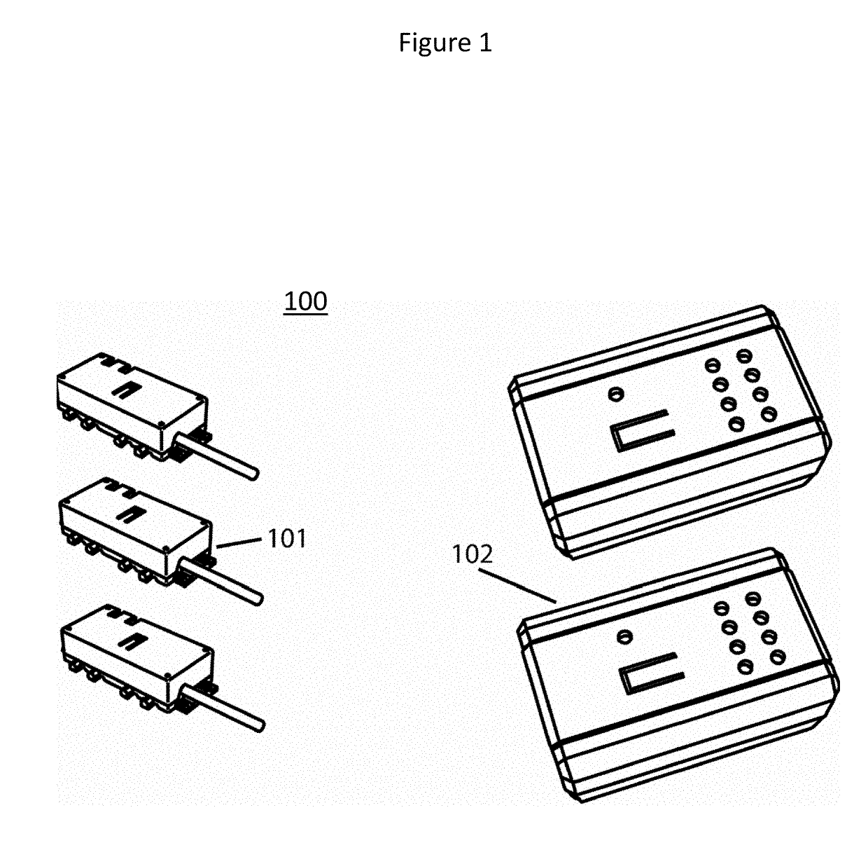

Embodiments of the present invention and their advantages may be understood by referring to FIGS. 1-6 wherein like reference numerals refer to like elements.

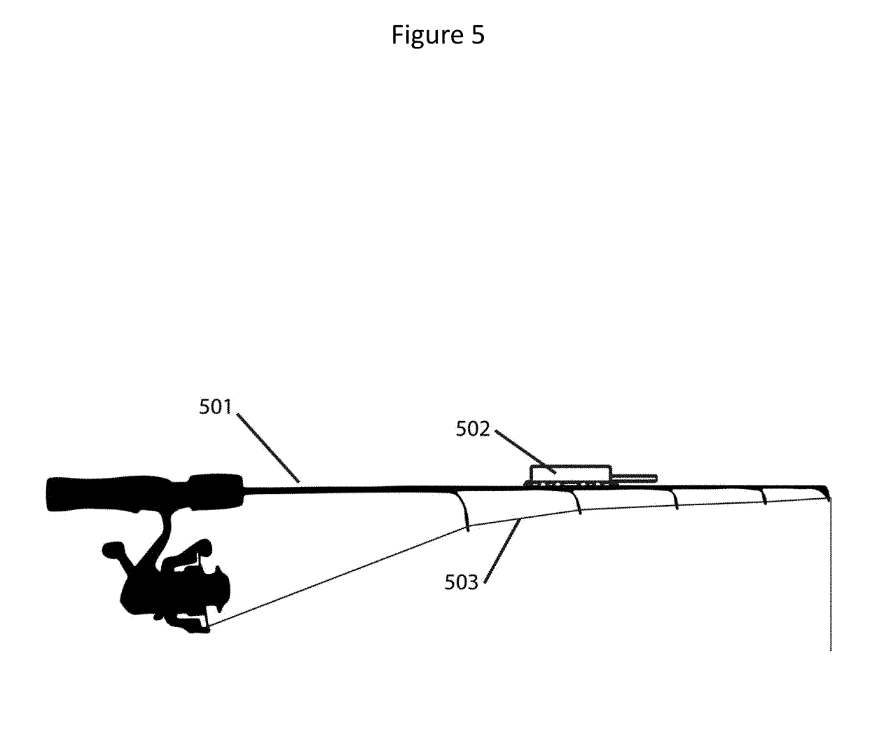

Referring to FIG. 1, an example system (100) is shown which includes three sensors (101) which would normally be mounted on the fishing apparatus (fishing rod, tip-up, tip-down, etc. as shown in FIG. 5) and two receivers (102) which would be carried by two users. The system is flexible in how it may be mounted and how the system may be configured with as many or as few sensors (101) and receivers (102) as the user requires for their particular situation. For example, in some U.S. States, users are allowed up to nine fishing rods at a time, for ice-fishing. Therefore, a user may require nine sensors to be monitored simultaneously with only one receiver, in an example.

The sensors (101) are connected to the receivers (102) through a means for remote monitoring. This connection is preferably wireless and may be a proprietary protocol, for example a Hamming-code sent at 433 MHz. However, the connection could also use any of a variety of methods including Bluetooth, Wi-Fi, NFC, light or infrared, inductive, capacitive or other technologies known in the art.

FIG. 5 shows an example of the sensor (502) mounted on an ice fishing rod (501). It can be seen in this example that the sensor (502) can be mounted anywhere along the length of the fishing rod, it does not have to be mounted at the tip or the handle of the rod. The sensor does not attach to the fishing line (503) to ensure it will not interfere with fishing activities. This is one example of fishing equipment. For a tip-up rig the sensor could be mounted on the flag. For a tip-down rig the sensor could be mounted on the arm. For trolling, casting and shore equipment the sensor could be mounted on the rod. For other types of fishing the sensor would be mounted in any location on the fishing apparatus that will experience motion (vibration, rotation or lateral acceleration in any axis on, for example, the rod, the handle, or the reel).

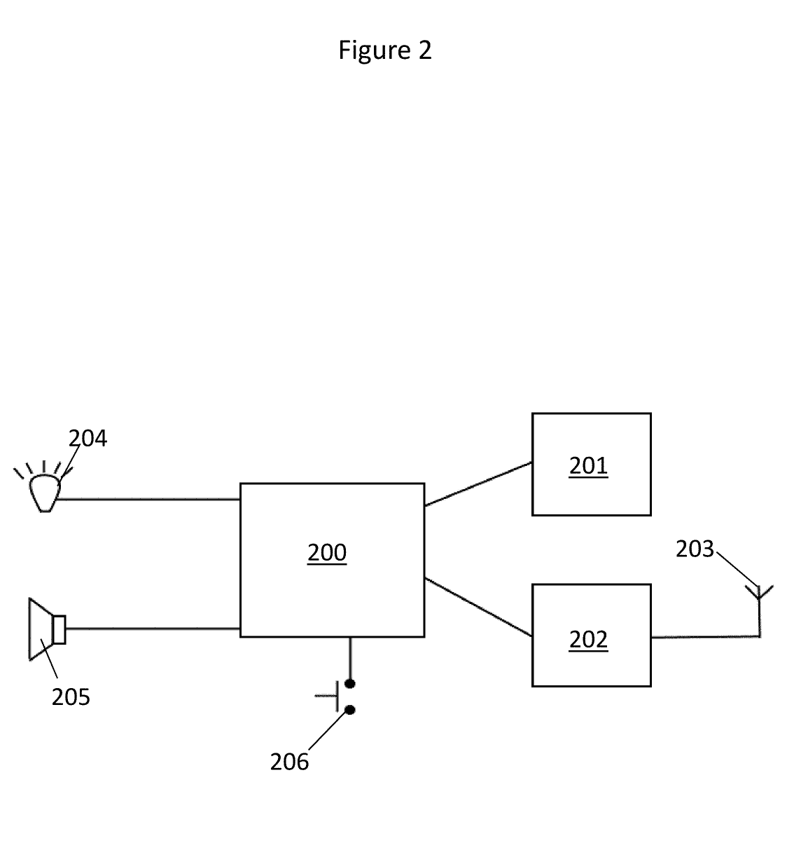

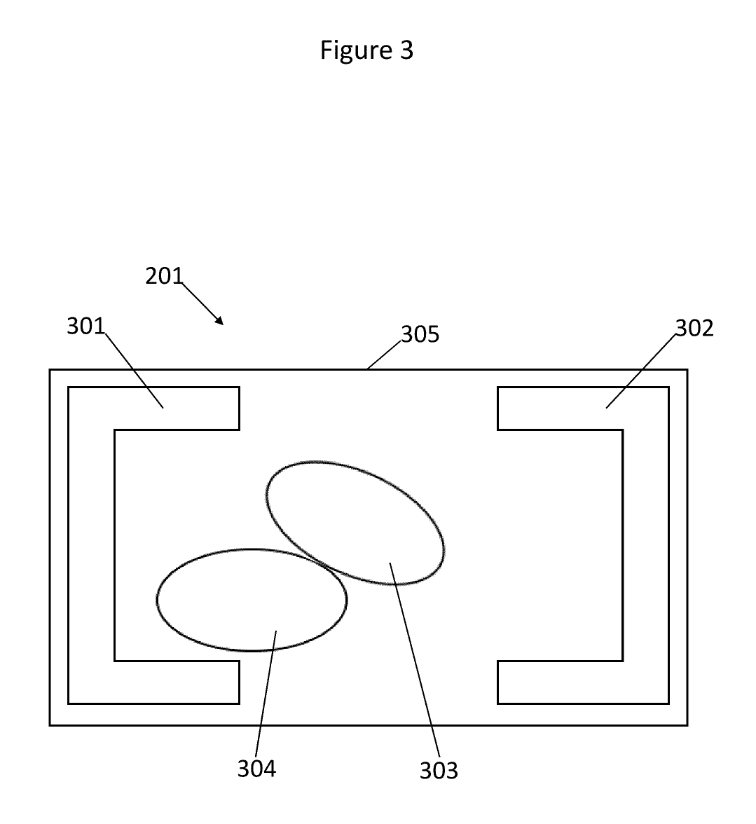

FIG. 2 shows a block diagram of one of the sensors (101). The sensors include a motion sensing component (201) which will be described in more detail in the description of FIG. 3, below. The sensor also includes a microprocessor (200), a wireless communication link (202) (at least transmitting, for transmitting status to a receiver unit, an antenna (203), optionally, one or more user interface button(s) (206), an audible signal (205) and/or a visual indicator (204). The sensor is powered by a power source such as a battery. The components may be mounted on a PCB and in communication with each other, and may be enclosed within a waterproof housing. The housing may be fastened to the rod in a number of ways, using a bracket, strap or ziptie, adhesive or direct fastener like a screw.

When the motion detector (201) is in motion it will create a series of pulses to the microprocessor (200). Alternatively, it provides a data signal containing data regarding the detectors' movement. Sensitivity adjustment can be performed at the sensor by allowing the user to select the allowable number of pulses. In an embodiment, a series of criteria will be used by the microprocessor (200) to validate the motion signals from the motion detector (201). In a further embodiment, described later, the microprocessor carries out automatic adjustment and “learns”, or is calibrated, to determine the motion detector output that provides a motion signal. For example, the sensor may have three sensitivity levels, Low, Medium and High. The user would press the button (206) and the visual indicator (204) could flash once for Low, twice for Medium and three times for High sensitivity, or with a differing intensity, pattern or colors to indicate the sensitivity level. Each sensitivity level may be associated with a specific number of pulses from the motion sensor in a given period of time. For example, a setting of High sensitivity may mean that only two pulses must be received from the motion detector while Medium sensitivity may require ten pulses and Low sensitivity may require twenty pulses. These pulses would be counted over a short period of time, for example one second.

In an alternate embodiment, the sensor may send information to the receiver with respect to the amount of motion detected and the receiver would apply the validation criteria to determine if a bite had occurred or if the motion was an artifact of environmental conditions such as wind or waves.

Different types of motion detectors may have different types of output to the processor. The system could use an accelerometer which provides information in digital or in analog format. The sensor must be very sensitive and provide information about motion in any axis that would include tilting and vibration. Due to the high sensitivity requirements, an accelerometer today would be too expensive to use in place of a mechanical motion sensor, however, in the future it is anticipated that motion-sensing devices based on solid-state or MEMs technology could be used. The use of a mult-axis accelerometer would further enhance the ability of the sensor to distinguish between environmental conditions of wind and waves as opposed to a fish biting, this could be done by applying different filtering and threshold criteria to each separate axis of the accelerometer.

The visual indicator (204) also serves as a night location beacon. The visual indicator will flash periodically to aid the user in locating the sensor (and hence the fishing rod) at night. The rate the visual indicator flashes at will be dependent on the design choices for the product. For example, a flash rate of about once every five seconds with an illumination period of less than 100 ms is sufficient to provide a visual cue to location without placing a strain on the batteries powering the sensor. The visual indicator can also be setup with multiple separate indicators to provide information to the user about the battery status, sensitivity settings and other information. In another embodiment, the visual indicator may also be separate from a location beacon.

When motion is detected and the microprocessor confirms that the motion exceeds a pre-determined threshold for a valid fish bite, the microprocessor will provide an alarm signal that may include the audible indicator (205) and visual indicator (204). The microprocessor will also send information to the receiver through the wireless link (202). In an embodiment the alarm indication period lasts for 30 seconds and will include flashing the visual indicator once per second at a 50 percent duty cycle, and beeping the audible indicator (205) at the same rate. The audible indicator may change tone, pitch or duration, and the visual indicator light color, intensity or duration, according to the design preferences of the system. After this initial alarm indication period the beeper will be turned off and the visual indicator will flash at a rate of once per second at a 5 percent duty cycle. This second alarm indication period would preferably last for over an hour. This second alarm period provides a visual indication to the user that a bite was detected, but not dealt with, and that they should therefore check to ensure a fish is not already hooked or that the bait has not been lost. An audible signal may also be emitted periodically over the second alarm period, but at a rate that is less than the first alarm rate.

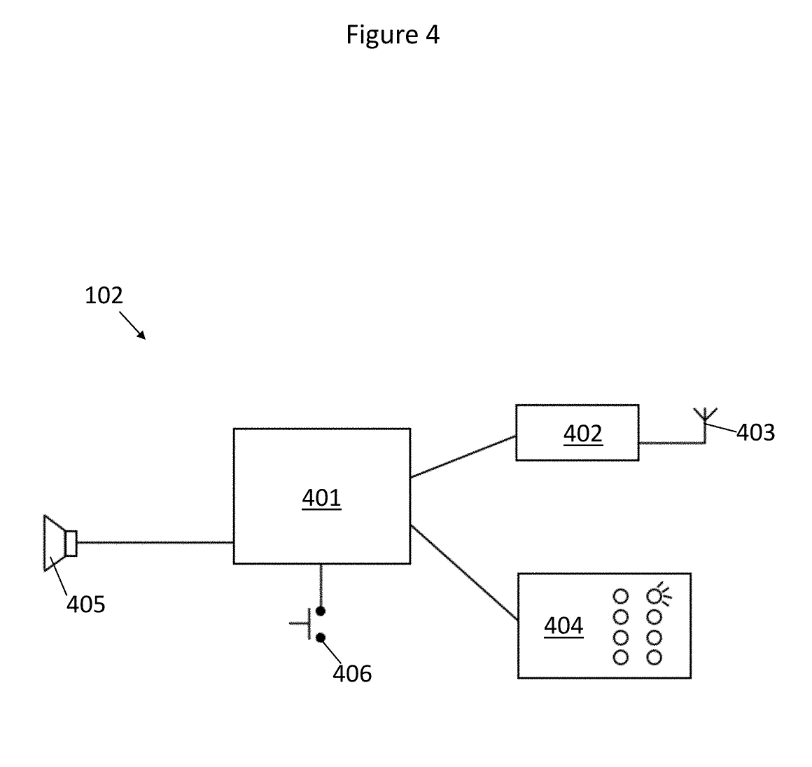

When the user hears the alarm signal, they may attend to the fishing equipment to determine if a fish has already been, or can be, hooked. During this time the user may clear the alarm by pressing a button, which communicates a command to the microprocessor to stop beeping and flashing. In an embodiment the sensor will transmit an all-clear message to the receiver unit (shown in FIG. 4) so it too will stop beeping.

The user may also clear the alarm by providing a mechanical signal to the sensor that is distinct from both environmental conditions and a fish biting. When the user provides a fast jerk on the fishing rod to secure the fish, this easily distinguished motion can be used to automatically clear an active fish-bite alarm. Similarly, rather than pushing the button on the sensor to clear the alarm, the user could slap the fishing rod with the palm of their hand to create a quick, easily distinguished, motion at the sensor. The clearing function may only be monitored during a specific time period after a fish bite has been detected. This would prevent a large fish that aggressively bites the bait from causing the bite alarm to accidentally clear.

Other user control functions could also be added such as interpreting two transient motions in rapid sequence (related to slapping the fishing rod twice) as the user wishing to adjust the sensitivity level of the sensor.

FIG. 3 shows an example electromechanical motion detector (201). Two or more conductive elements (303, 304), in an embodiment in the shape of prolate spheroids, are located between two electrical contact cups (301, 302). The assembly is then encased in a rigid housing (305). The elements that make up the detector are sized such that they are typically in an unstable but conductive arrangement. The prolate spheroids are sufficiently light that when the detector is tilted or moved in any way they move relative to each other and to the contact cups, creating electrical noise at multiple interface points as current is passed through the sensor, which is then sensed as pulses by the microprocessor. The detector is therefore sensitive to any motion including vibration and tilting. The detector is biased to detecting sudden or sharp motions, as sharp motions such as the tap or pull of a fish will generate more electrical noise as the prolate spheroids will be rattled inside the housing, while a slower motion such as waves will generate very little electrical noise as the prolate spheroids will tend to stay in electrical contact with each other most of the time, creating less electrical noise. The conductive elements may be formed of other shapes, including spheres, extended ovoids or capsule-shapes.

It would be possible to combine tilt detectors and a vibration detector on the same circuit board to achieve a similar, though more complex and expensive result as the motion sensor proposed as an embodiment. In fact, such circuits, both accelerometers and tilt sensors, are known in the art, and may also be available in an integrated variable capacitive, inductive, or resistive architecture or surface mounted chip component. However, multiple tilt and vibration sensing devices would need to be used to ensure that motion in any axis was detected.

In an alternate embodiment, automatic adjustment to environmental conditions may be implemented by continuously monitoring the motion detector and recording the amount of average detected motion over a period of time, and setting thresholds at the edges of the motion extremes for amplitude and slope (suddenness) of the movement. The user would still set the desired sensitivity level that will trigger a bite alarm, but in this case the sensitivity level would be used to set a threshold amount of motion required above the average detected motion. In this way constant motion created by waves or wind will not trigger the alarm while the tap of a fish will be detected due to the motion range exceeding the threshold. Additional signal processing can be used to further refine the distinction between background motion and an actual fish bite. For example, the microprocessor could filter out repeated motion that is at a frequency similar to wave motion. This type of additional signal processing may be better suited to a more expensive and complex system that includes a sensitive accelerometer rather than the electromechanical sensor shown in FIG. 3.

FIG. 4 shows the Receiver (102) which includes a microprocessor (401) connected to a wireless receiver circuit (402) and antenna (403) configured to communicate with the one or more sensors attached to the fishing lines. An audible (405) indicator may comprise a speaker or piezoelectric buzzer to emit an audible sound that can be used to alert the user of a bite or other situation that requires attention. One or more button(s) (406) allow user input and a display (404) provides feedback to the user and may provide status of the complete system including the receiver itself and any sensors that are being monitored. The display (404) may be composed of one or more individual indicators such as light emitting diodes (LED) or it may be an alpha-numeric, graphic, liquid crystal, light emitting diode or other type of display capable of providing an substantial level of information to the user. In an embodiment, the receiver is a stand-alone electronic device contained within a housing and having battery power, and in another embodiment the receiver is a smartphone running an app to facilitate monitoring of the fishing lines.

When a sensor detects and validates that a fish is biting, it sends an alarm message to the receiver that alerts the user to the bite. If the user acknowledges the bite by performing an action such as pushing a button or tapping the screen on the receiver or on the sensor, then the alarm condition is cleared until another bite is detected. A bite tally is updated for the sensor, to provide a record of the action on each line during the day. If the user does not acknowledge the bite then the system will eventually display a different notification so the user knows that they missed a bite and can take appropriate action such as checking their lines for hooked fish or lost bait. In an embodiment both the sensor and the receiver will indicate an immediate bite-alarm condition for about 30 seconds followed by a period of indicating a missed bite for about one hour.

In an embodiment, the user will be able to ignore a false alarm without risking missing a real fish bite. Occasionally a sensor may incorrectly generate a bite alarm when no fish is present, such as if a large gust of wind shook the sensor and the range of the threshold is exceeded. If it is inconvenient for the user to service the alarm (for example they may be ice fishing and inside a warm tent, yet able to verify that a tip-up flag has not been triggered on their equipment outside the tent) the user can push the button on the receiver to temporarily silence the alarm. In an embodiment, after about 30 seconds the immediate bite-alarm at the sensor will finish and no longer attempt to notify the receiver. If another bite occurs after this 30-second period, then the sensor will transmit a new immediate bite-alarm to the receiver and the user will be notified that a new bite has been detected. With luck this time it will be a real fish that has taken the bait.

Multiple people may be fishing in the same area using this wireless product. Cooperative fishing is common among outdoor enthusiasts; therefore the system must be capable of being configured for both cooperative fishing and for people who are fishing alone but in an environment with other fishers.

To create a cooperative network, the receiver preferably includes a synchronization function where pressing a button causes the receiver to look for new sensors for a short period of time, for example 10 seconds. If a sensor is then turned on within range of the receiver during the synchronization period then the receiver will assume that it should begin to monitor that sensor. The receiver will only monitor sensors that are turned on within the synchronization window. Or there may be an alternative handshake process wherein the particular sensor is recognized by the receiver and monitored using a combination of user inputs. A number of users on the cooperative network may each monitor multiple lines at the same time and receive updates of the lines in real time. Any one of the users may silence a line but the receivers maintain a history of each line so the line sensor status may be revisited. Further, there may be a communication facility between users built into the receiver or app, that enables communication regarding the status of particular lines.

Each sensor has its own randomly generated address or fixed (MAC) address. Therefore, if the sensor is turned off and on, or the receiver is turned off and on, the unit will remain paired through the use of these addresses.

Each receiver can monitor more than one sensor simultaneously by continuously listening for transmitted information from every sensor for which it knows the address. This allows many sensors to transmit to one receiver, satisfying the need for a many-to-one setup. The status for multiple sensors may be shown simultaneously on the screen of the receiver.

In one embodiment, cooperative fishing is achieved by powering the sensor off and on within range of a receiver that is operating in its synchronization window. Once turned on, the sensor information will be received by any receiver that was previously synchronized to it due to its unique address. In this way multiple receivers can be setup to listen to a single sensor. Each fisher can therefore monitor the other fisher's sensor if so desired, this allows one sensor to transmit information to many receivers, satisfying the need for a one-to-many setup.

The system therefore supports a many-to-one and a one-to-many transmit/receiver approach and will support both types of communication simultaneously.

Other protocols for communication can also be supported. For example, the sensors could contain a Bluetooth transmitter. This would allow the receiver as described to be virtualized into a smart-phone application or displayed on another type of computer system. Other types of fishing equipment such as depth-finders and global positioning systems already contain a display and microprocessor and would therefore be ideal candidates to receive and display information from the fish bite sensors.

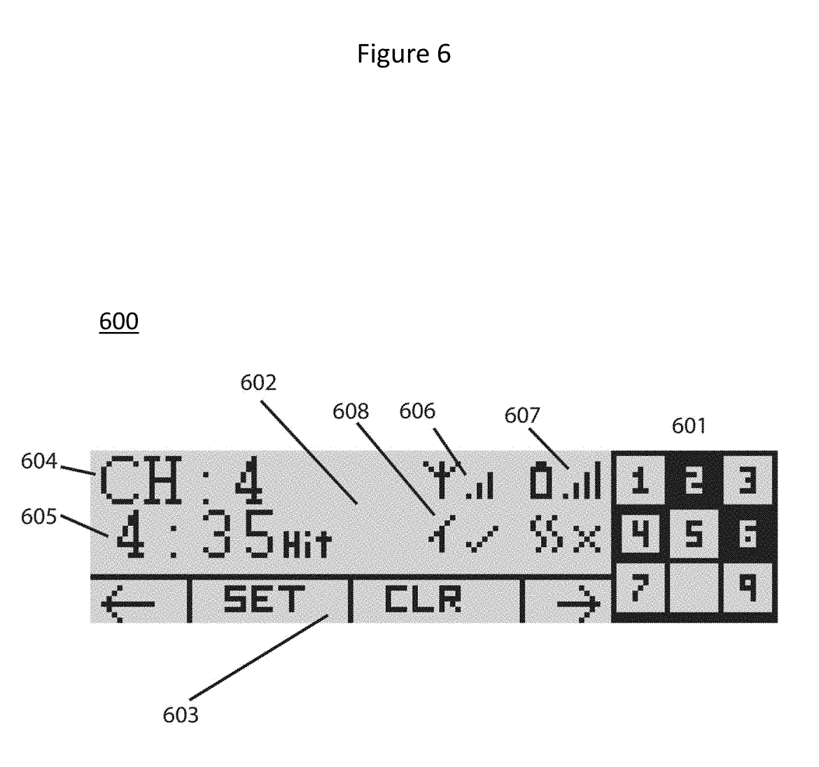

FIG. 6 shows an example display for the receiver system. This display (600) could be implemented on a stand-alone screen such as liquid crystal (LCD), Light emitting diode (LED or OLED), or similar, as known in the art. The display (600) could also be part of an application that runs on a smart phone, tablet or other computer system. This is only an example of the types of information and layout that could be used for such an application. The display includes an overview section (601) which can provide a quick-view status of all sensors being monitored. In this example there is room for 9 sensors, however in other embodiments more or fewer sensors may be used. Sensor numbers 1, 3, 5, 7 and 9 are shown with black lettering on a clear background, wherein in an embodiment this could indicate that there is no activity on that sensor. Sensor numbers 2 and 6 show clear lettering on a black background, which in an embodiment may indicate that a bite occurred sometime in the past. Sensor 8, which is absent, is clear lettering on a clear background showing that this sensor is not being used, is off, or has lost communication. Sensor 4 is flashing, in this embodiment represented as a thicker window around the number, which could indicate that the sensor is actively in motion due to an ongoing fish biting.

The detailed window (602) provides more information on a specific sensor. In this example Sensor number (604) (labeled as CH:4, or sensor 4) is shown in detail. The time of the last fish bite (605) is shown as well as the signal strength of the wireless connection (606) the battery level (607) of the sensor, and any other sensor settings (608) such as sensitivity or the type of fishing equipment. A menu or control area (603) may also be included which would provide the user with a navigation method to look at other sensors by using push-buttons, touch-screen or other user-input means, and to scroll through menu options

Although the description above contains much specificity, these should not be construed as limiting the scope of the invention but as merely providing illustrations of an embodiment of this invention. Thus, the scope of the invention should be determined by the appended claims and their legal equivalents.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A fish bite monitoring system which comprising:
a. at least one motion sensor for detecting when a fish is biting;
b. an audible and visual indicator in the sensor to alert the user;
c. a user input means in the sensor to change a sensitivity level of the sensor between at least two different states;
d. a user input means to acknowledge or clear alarms;
e. at least one receiver wirelessly connected to the at least one sensor for receiving information from the sensor;
f. an audible and visual indicator in the receiver to alert the user; and
g. a user input means in the receiver to acknowledge or clear alarms,
wherein the at least one sensor and/or at least one receiver includes an immediate alarm state when motion is present and a historical alarm state when motion has ceased, and wherein the system is connectable to a fishing device.

2. The system of claim 1, wherein the at least one sensor comprises a motion detector element comprising:
a. a microprocessor;
b. two or more conductive particles;
c. two conductive cups, wherein the particles are disposed between two conductive cups such that vibration or tilting of the detector element misaligns the particles and creates an electrical signal, wherein the microprocessor is electrically connected to the cups, and wherein the signal is interpreted by an attached microprocessor.

3. The system of claim 2, wherein the particles are prolate spheroids.

4. The system of claim 1, wherein the at least one sensor includes a motion detector element composed of a multi-axis accelerometer.

5. The system of claim 1, wherein the at least one sensor visual indicator includes a beacon function.

6. The system of claim 1, wherein the user input means to acknowledge or clear alarms when actuated on the at least one sensor will also acknowledge or clear alarms on the receiver.

7. The system of claim 1, wherein multiple sensors may wirelessly connect to a receiver.

8. The system of claim 1, wherein multiple receivers may wirelessly connect to a sensor.

9. The system of claim 1, wherein a single receiver may connect to multiple sensors.

10. The system of claim 1, wherein the at least one sensor includes an automatic adjustment means to reject environmentally induced motion.

11. A fish bite monitoring system which comprising:
a. one or more motion sensors having an alarm, an interface, and a wireless transceiver; and
b. one or more receivers, each receiver having a wireless transceiver, an alarm system, and a user interface,
wherein each motion sensor is attached to a fishing rod, and wherein motion of the fishing rod triggers the alarm of the attached motion sensor, and wherein the triggered alarm of the attached motion sensor triggers the alarm system at least one of the one or more receivers.

12. The system of claim 11 wherein the one or more motion sensors further comprise a motion detector element having
a. a microprocessor;
b. two or more conductive particles; and
c. two conductive cups,
wherein the conductive particles are disposed between two conductive cups such that vibration or tilting of the detector element misaligns the conductive particles and creates an electric signal, wherein the microprocessor is electrically connected to the cups, and wherein the electric signal is interpreted by the microprocessor.

13. The system of claim 12, wherein the electric signal is assigned a threshold value, and wherein the user is able to set the threshold value using the interface of the one or more sensors and/or the user interface of the one or more receivers.

14. The system of claim 13, wherein the particles are prolate spheroids.

15. The system of claim 11, wherein the one or more motion sensors are further comprised of a multi-axis accelerometer.

16. The system of claim 12, wherein the motion detector element further comprised of a multi-axis accelerometer

17. The system of claim 11, wherein the one or more sensors include an automatic adjustment means to reject environmentally induced motion.

18. A fish bite monitoring system which comprising:
a. one or more motion sensors having an alarm, an interface, a wireless transceiver, and a motion detector element having
a microprocessor, two or more conductive particles, and two conductive cups,
wherein the conductive particles are disposed between two conductive cups such that vibration or tilting of the detector element misaligns the conductive particles and creates an electric signal, wherein the microprocessor is electrically connected to the cups, and wherein the electric signal is interpreted by the microprocessor; and
b. one or more receivers, each receiver having a wireless transceiver, an alarm system, and a user interface,
wherein each of the one or more motion sensors is attached to a fishing rod, and wherein motion of the fishing rod triggers the alarm of the attached motion sensor, and wherein the triggered alarm of the attached motion sensor triggers the alarm system at least one of the one or more receivers.

19. The system of claim 18, wherein the motion detector element further comprises a multi-axis accelerometer.

20. The system of claim 19, wherein the electric signal is assigned a threshold value, and wherein the user is able to set the threshold value using the interface of the one or more sensors and/or the user interface of the one or more receivers.
